(19) United States
(12) Patent Application Publication
(10) Pub. No.: US 2003/0107182 A1
(43) Pub. Date: Jun. 12, 2003

(54) Seal of a pressure chamber

(76) Inventors: Martin Lechner, Stuttgart (DE); Klaus Pesch, Leverkusen (DE)

Correspondence Address: COLLARD & ROE, P.C., 1077 Northern Boulevard, Roslyn, NY, 11576-1696, US

(21) Appl. No.: 10/292,696

(22) Filed: Nov. 12, 2002

(30) Foreign Application Priority Data
Nov. 13, 2001 (DE) 101 55 694.2

(51) Int. Cl. F02F 5/00

(52) U.S. Cl. 277/436

(57) ABSTRACT

A seal of a pressure chamber, in which the pressure chamber has boundary walls movable toward one another and an annular gap, filled up by a radial seal, between a first and a second of the boundary walls, these boundary walls being implemented as seal surfaces radially contacted by the radial seal and the seal being mounted so it is axially movable in relation to both radial seal surfaces and the radial seal also radially adjoining the inside of the pressure chamber, which is subjected to pressure, predominantly without being covered and able to support itself on the opposite axial side on a support connected to one of the boundary walls, is to be able to have a pressure damping effect for pressure pulsations within the pressure chamber.

For this purpose, the seal, which is in the form of a radial seal, is implemented, at least in the section which may press against the support, as an elastically deformable damping region.

The present invention relates to a seal of a pressure chamber according to the preamble of patent claim 1.

Such a seal is known, for example, from German Patent Application 24 58 974 A1.

The present invention is concerned with the problem of providing a pressure chamber according to the species with a damping device against pressure pulsations in a constructively simple and functionally effective way.

This object is achieved according to the present invention by a seal according to the species according to the characterizing feature of patent claim 1.

Expedient embodiments of this invention are objects of the subclaims.

The present invention is based on the general idea of implementing a radial seal simultaneously as a damping device and, for this purpose, subjecting it as unrestrictedly as possible, i.e. without covering, to the pressure area in which the pressure pulsations are to be damped.

In the implementation of the damping region of the seal it is important that a sufficient deformation region is available, since otherwise no damping may be achieved. This means that the seal material in the damping region, if it is not compressible per se, must have a clearance in relation to the adjoining sealing surfaces, in which the deformation may occur. Due to the deformability of the seal, in the event of elevation of pressure within the pressure area, an at least temporary increase in volume occurs, i.e., an increase in volume which is removed when the increase in pressure is reduced.

An advantageous exemplary embodiment of the present invention is illustrated in the drawing.

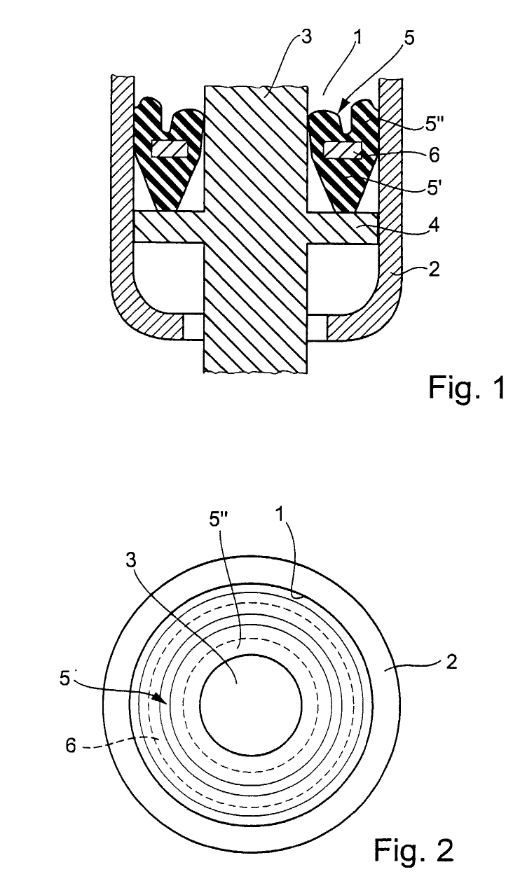

FIG. 1 shows a section through an axial end region of a pressure chamber,

FIG. 2 shows a top view of the pressure chamber shown in FIG. 1.

A hydraulic pressure chamber 1 is delimited by a first boundary wall 2 and a second boundary wall 3. In this case, second boundary wall 3 is implemented as a movable piston and first boundary wall 2 is implemented as cylinder, in which first boundary wall 2 is mounted so it is axially displaceable. An axial support 4 for axial support of radial seal 5 is molded onto second boundary wall 3, which is implemented as a piston.

Pressure chamber 1 is implemented as an annular chamber having radial sealing walls, which are formed by first and second boundary walls 2, 3. Radial seal 5 has, in relation to its axial extension, a damping region 5′, which may press against support 4, and a seal region 5″, which directly adjoins pressure chamber 1.

Seal region 5″ is designed in a V-shape, with the open side of the V in the direction of pressure chamber 1. The radial seal is achieved by the ends of the V-legs of seal region 5″. A stiffening ring 6 is inserted between damping region 5′ and seal region 5″ of radial seal 5.

Radial seal 5 is implemented as an annular cone in damping region 5′, in which the narrow face presses against support 4. In this region, radial seal 5 is elastically deformable to produce a damping effect. In this case, radial seal 5 is displaced axially in the direction toward support 4, the space above the annular cone, which is initially free of seal material, able to fill up with deformed seal material.

A compressible cavity may be provided in damping region 5′ within the seal material.

On the face diametrically opposite to support 4, radial seal 5 may be secured against lifting of support 4 by a stop, particularly a stop provided on second boundary wall 3. It is only important for the damping function according to the present invention that axial displacement of radial seal 5 is possible, which is necessary for the purpose of elastic deformation of the damping region.

The stiffening ring may be made of metal.

1. A seal of a pressure chamber, in which the pressure chamber has boundary walls movable toward one another and an annular gap, filled up by a radial seal, between a first and a second boundary wall, these boundary walls being implemented as radial seal surfaces contacted by the radial seal and the radial seal being mounted so it is axially movable in relation to the two radial seal surfaces, able to support itself, on the axial face to which pressure is not applied, on a support connected to one of the boundary walls, and being made of elastically deformable material, characterized in that
the radial seal (5), at least in a section (5′) which may press against the support (4), is implemented as an element which may be axially shortened by elastic deformation.

2. The seal according to claim 1, characterized in that
the radial seal (5), in the non-shortened, i.e. non-deformed state, has a radial distance to at least one of the radial boundary walls in its section (5′).

3. The seal according to claim 1 or 2, characterized in that
the radial seal (5) has an insert (6) inside it made of a less elastic material.

4. The seal according to one of claims 1 to 3, characterized in that
the region of the radial seal (5) facing the pressure chamber (1) is implemented as V-shaped with a V side open toward the pressure space.

5. The seal according to one of claims 1 to 4, characterized in that
a cavity is provided in the deformation region (5′), which may be shortened.

6. The seal according to claim 5, characterized in that
the cavity is filled with a compressible fluid.
